(19) United States
(12) Patent Application Publication
(10) Pub. No.: US 2012/0140973 A1
(43) Pub. Date: Jun. 7, 2012

(54) COLLAPSIBLE HEADPHONE

(76) Inventors: Robert Olodort, Santa Monica, CA (US); Peter Cazalet, Campbell, CA (US)

(21) Appl. No.: 12/959,179

(22) Filed: Dec. 2, 2010

(51) Int. Cl. H04R 1/10

(52) U.S. Cl. 381/375; 381/379

(57) ABSTRACT

A headphone that is, in one embodiment, collapsible into a fully collapsed, self-protecting form factor, and includes a headband that mechanically interconnects the two earpieces and fits around the head when worn. The headband can optionally include one or more telescoping linkages to allow it to collapse in length. The headband is attached to each of the two earpieces by two hinges in one embodiment: one hinge connects the headband to an intermediate part, which exists between an earpiece and the headband, another hinge connects the intermediate part to its corresponding earpiece. The wrapping of the headband around the two earpieces can leave no part extending outside from the structure which resembles a hockey puck in one embodiment.

### FIELD OF THE INVENTION

The present invention is generally related to headphones, and more particularly is related to headphones that may be folded or collapsed.

### BACKGROUND OF THE INVENTION

Headphones typically include two earpieces designed to direct sound to the left and right ears and are connected together through a headband. Headphones, when in use on a user's head, can he large and bulky, since they are designed to be fitted over the head and cover the ears or fit with the ears. Thus headphones can be inconvenient to carry or store, and can require a large housing case.

To facilitate carrying or storing, some headphones can be collapsed or folded when not in use. For example, the earpieces can be mounted on slidable extensions, which can reduce the length of the headband when not in use. The headphones can also incorporate a pivot point. For example, certain foldable headphones contain a central hinge point on a headband to enable folding of the headphone in half.

Prior art foldable headphones are not protected from exterior elements or conditions. For example, the prior art headphones suffer from the disadvantages of elements which protrude from the headphones when folded or are not protected from external forces when folded.

### SUMMARY OF THE DESCRIPTION

The present invention discloses collapsible headphones and methods for collapsing the headphones. The present headphones can, in one embodiment, be collapsed into a fully collapsed, self-protecting form factor.

In an embodiment, the collapsible headphone comprises a first and second earpieces coupled to a headband which mechanically interconnects the two earpieces through a plurality of joints, and fits around the head when worn. The joints are configured to cause the headband, when the headphone is collapsed, to wrap around the earpieces at a peripheral portion of the earpieces. The sound outputting sides of the earpieces can face each other when fully collapsed. In one embodiment, the headphone can include a wireless transceiver to act as a peripheral for a cellular telephone or other telephone device; in another embodiment, the headphone can include a wireless receiver (without a transmitter) to act as a stereo output device for a music player (e.g. an MP3 player, etc.).

In an embodiment, in the collapsed configuration, the headband wraps around the earpieces without leaving a gap or without exhibiting a breakable protrusion. For example, the headband can wrap around the earpieces to form a cylindrical shape with the earpieces forming the bases of the cylinder and the headband forming the side of the cylinder. This configuration can protect the collapsed headphone, thus reducing the susceptibility of the headphone to being broken. In one embodiment, no protrusions extend from the collapsed headphone. In one embodiment, the headband, when wrapped around the two earpieces in their collapsed state, can create a flush surface which resembles a side of a cylinder.

In an embodiment, in the collapsed configuration, the headband wraps around the earpieces in a way to provide support to the earpieces against external forces, such as compressive or shear forces acting on the earpieces. The headband can comprise one or more telescoping linkages to allow it to collapse in length, for example, for adjusting the distance between the two earpieces when worn or collapsed. The telescoping elements can also allow the headphone to have a length compatible with the perimeter of the earpieces, allowing the headband to wrap around and between the earpieces within one turn.

In one embodiment, each of the earpieces can include a rim that attaches to one or more hinges that in turn are coupled to one side of the headband. The rim can surround and he coupled to a cylindrical side of each earpiece and have a perimeter that is larger than a perimeter of a side of the earpiece which is adjacent to a sound output surface of the earpiece; in other words, the side of each earpiece includes a portion that does not include the rim and a portion that includes the rim. The sound output surface of each earpiece can be immediately adjacent to the portion of the side of the earpiece that does not include the rim and an opposite surface of the earpiece (which faces away from the user's ear can be immediately adjacent to the rim on the side of the earpiece. The headband can be sized to fit between the rims, in a flush fashion, when the headphone is collapsed; in particular, the headband, when wrapped around both earpieces can be between and adjacent to the rim of each earpiece, and in this configuration, the headband and both rims can protect the earpieces from damage due to a force applied in a direction perpendicular to the sound output surfaces of the two earpieces. For example, a user could step on the collapsed earpieces without damaging them when the headband and the two rims are sized and made from a material that can withstand the user's weight.

In an embodiment, the headband is attached to each of the two earpieces by two hinges: a first hinge connects the headband to an intermediate part, which exists between an earpiece and the headband, a second hinge connects the intermediate part to its corresponding earpiece. These two hinges can be orthogonal to each other and permit rotations about two axes that are perpendicular to each other. The wrapping of the headband around the two earpieces, in one embodiment, leaves no part extending outside from the collapsed structure which resembles a hockey puck.

The present invention also discloses methods to collapse the collapsible headphone, and in one embodiment the method can comprise rotating the joints between the earpieces and the headband so that the earpieces are facing each other and wrapping the headband around a peripheral portion of the earpieces.

In an embodiment, each of the two earpieces is rotated relative to the headband so that the headband is substantially tangential to a side portion of the earpiece. The headband (or the earpieces) is then moved relative to the earpieces (or the headband) so that the headband wraps around the earpieces. The collapsed headphone then can have no gap between the headband and the earpieces, no breakable element extending from the collapsed headphone, or having the headband support the earpieces from external forces. In an embodiment, the headphones, after being collapsed, form a cylindrical shape.

In an embodiment, the telescoping elements of the headphone are retracted, leaving the headband with a desirable length for wrapping around the earpieces.

In an embodiment, the earpiece is rotated in a first direction and then in a second direction relative to the headband. For example, the earpiece is rotated about substantially 90 degrees in a first direction perpendicular to the length of the headband, and then in a second direction perpendicular to the length of the headband.

Other elements can be included in the headphone, such as microphone, earpiece jack, and wireless receiver system including circuitry, antenna and battery or a wireless transceiver system including circuitry, one or more antennas, and battery. The transceiver can be used when the collapsible headphone is used as an input and an output device for a cellular telephone.

### BRIEF DESCRIPTION OF THE DRAWINGS

FIGS. 1A and 1B illustrate an exemplary collapsible headphone according to an embodiment of the present invention. FIGS. 1C through 1R show the transition between collapsed and expanded states for the collapsible headphone shown in FIGS. 1A and 1B.

FIGS. 2A and 2B illustrate telescoping configurations according to embodiments of the present invention.

FIGS. 3A-3C illustrate exemplary configurations for the earpieces according to embodiments of the present invention.

FIG. 4 illustrates an exemplary rotatable earpiece according to an embodiment of the present invention.

FIGS. 5A and 5B illustrate an exemplary set of hinges coupling a headband with an earpiece according to an embodiment of the present invention.

FIGS. 6A and 6B illustrate an exemplary set of ball joints coupling a headband with an earpiece according to an embodiment of the present invention.

FIGS. 7A-7C illustrate partially and fully collapsed configurations for the present headphone according to an embodiment of the present invention.

FIGS. 8A-8B illustrate other fully collapsed configurations for the present headphone according to embodiments of the present invention.

FIGS. 9A-9C illustrate partially and fully collapsed configurations for the present headphone according to another embodiment of the present invention.

FIG. 10 illustrates an exemplary collapsible headphone according to an embodiment of the present invention.

FIG. 11 illustrates an exemplary flowchart for collapsing a headphone according to an embodiment of the present invention.

FIG. 12A shows an enlarged version of FIG. 1R; FIG. 12B shows an enlarged version of the configuration shown in FIG. 1J; FIG. 12C shows an enlarged version of the configuration shown in FIG. 1H; and FIG. 12D shows the headphone of FIGS. 12A-12C after it is fully collapsed.

### DETAILED DESCRIPTION

In an embodiment, the present invention discloses a collapsible headphone in which the headphone, when collapsed, can be small and compact for ease of portability. In addition, the present headphones can he collapsed to a self-protecting form factor, presenting a damage-proof structure that can provide protection from accidental forces during transport or mishaps, such as being squeezed, bent or stepped on. For example, the present headphone, when collapsed, can form a short cylindrical structure that resembles a hockey puck with the two earpieces facing each other and the headband wrapping around a side of the earpieces between two rims, one rim on each of the earpieces. In the collapsed configuration, the headband can wrap around the earpieces without leaving a gap or without exhibiting any protrusion of a part from the hockey puck form factor. Also, the wrapping of the headband around the earpieces can provide support to the earpieces against external forces. The headphone can be an output only device (e.g. for use as an output device for a stereo system as a wireless or wired peripheral of the stereo system) or can be an input and output device for use with, for example, a cellular telephone, in either a wireless or wired mode with the cellular telephone.

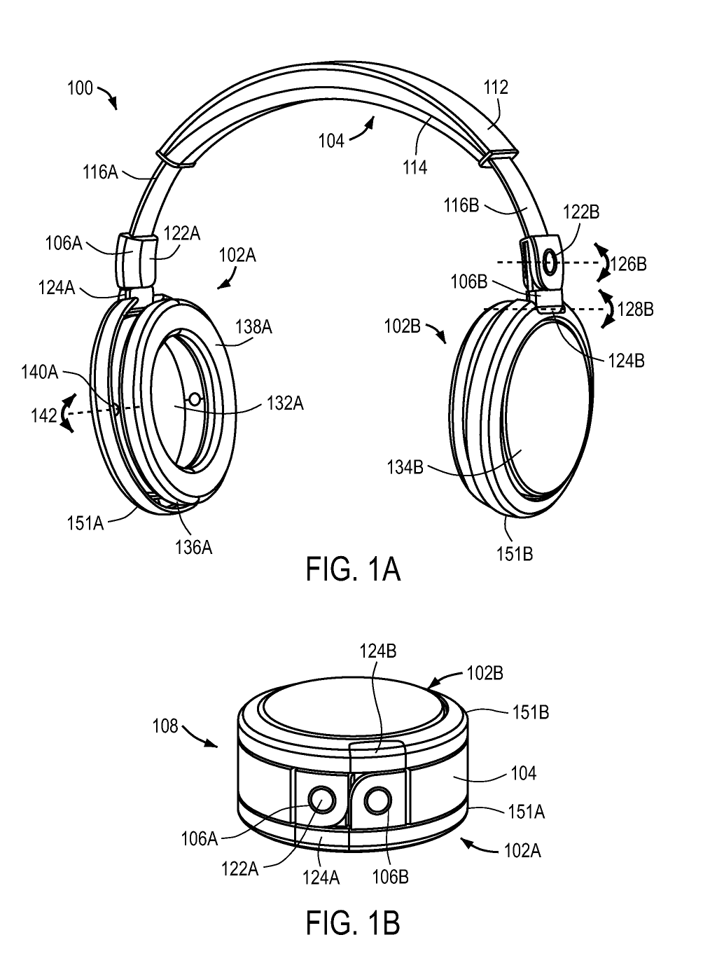

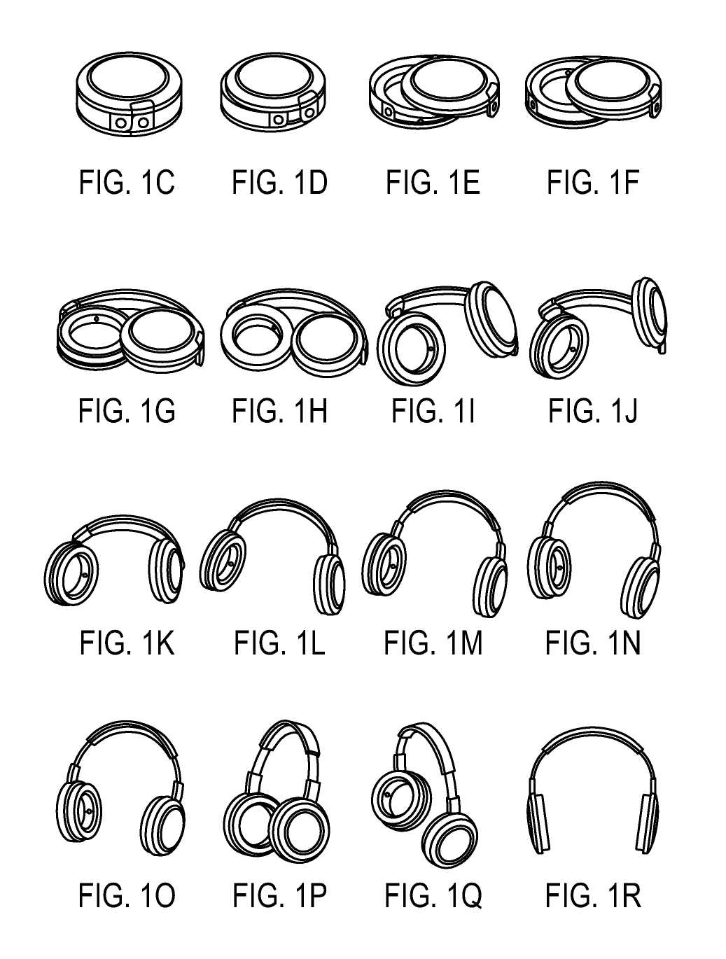

In an embodiment, the collapsible headphone comprises a headband, two earpieces and a plurality of joints connecting the earpieces to the headband. The joints are configured to allow the collapse of the headphone into a small, self-protecting form factor. FIGS. 1A and 1B illustrate an exemplary collapsible headphone according to an embodiment of the present invention. FIG. 1A illustrates the collapsible headphone in an expanded configuration, ready to be used. FIG. 1B illustrates the collapsible headphone of FIG. 1A in a collapsed configuration, ready for storage or transport. FIGS. 1C through 1R show the transition between the form factor shown in FIG. 1A and the form factor shown in FIG. 1B.

As shown in FIG. 1A, the exemplary headphone 100 comprises two earpieces 102A and 102B, a headband 104, and joints 106A and 106B connecting the earpieces 102A and 102B to the headband 104. The joints 106A and 106B are designed to allow collapsing the collapsible headphone 100 into a compact collapsed configuration, for example, the collapsed configuration 108 shown in FIG. 1B where the headband 104 wraps around the earpieces 102A and 102B to form a short cylindrical structure that resembles a hockey puck. The headband can create, as shown in FIG. 1B, a surface that is flush on the side of the earpieces, and this surface resembles a cylinder's side. Note that each of the earpieces includes a rim that holds its respective earpiece and is also attached to the headband 104. In particular, earpiece 102A has a rim 151A that is coupled to the earpiece 102A and is also coupled to joint 106A which is coupled to headband 104, and earpiece 102B has a rim 151B that is coupled to the earpiece 102B and is also coupled to joint 106B which is coupled to headband 104. Also note that, in the collapsed configuration shown in FIG. 1B, the headband 104 wraps around both earpieces and is disposed between rims 151A and 151B and has the same outer diameter as the rims 151A and 151B; in the collapsed configuration of FIG. 1B, the headband 104 and the rims 151A and 151B are flush with no elements protruding beyond the headband 104 and the rims 151A and 151B.

In an embodiment, the headband 104 comprises a resilient support portion 112 with a soft liner 114 facing the person's head when worn. The soft liner 114, provided for user comfort, can be made of a flexible material such as foamed plastic, covering a substantial length and width of the lower surface of the support portion 112.

In an embodiment, the headband 104 comprises telescoping elements 116A and 116B, extending and retracting within the headband 104. The telescoping elements 116A and 116B can allow adjusting the length of the headband, for example, to fit the earpieces to the person's ears. The telescoping elements 116A and 116B can also allow the headband to wrap with one turn around the earpieces in the collapsed configuration 108 shown in FIG. 1B.

In an embodiment, the joints 106A and 106B each comprises two hinges. For example, hinges 122B and 124B are shown for joint 106B. Hinge 122B allows the earpiece 102B to rotate in a first direction 126B perpendicular to the headband 104. Hinge 124B allows the earpiece 102B to rotate in a second direction 128B perpendicular to the headband 104. Joint 106A comprises a similar hinge configuration. Hinges 122A and 124A are shown for joint 106A. The combination of the hinges allows the headphone to be collapsed to a compact configuration 108. The coupling between the earpieces and the headband can also be achieved, in alternative embodiments, by any method or apparatus providing rotations of the earpieces with respect to the headband, for example, a shaft, or ball and joint configuration.

In an embodiment, the earpieces 102A and 102B each comprises a sound outputting element such as a speaker (not shown enclosed in a circular housing. Each earpiece 102A and 102B comprises an inner side (132A shown for earpiece 102A), an outer side (134B shown earpiece 102B) and a circumference side (136A shown for earpiece 102A). The inner side represents a sound outputting surface facing the person's ear. The outer side represents an opposite surface to the sound outputting surface. The earpieces can also comprise ear pads (138A shown for earpiece 102A), mounted on the sound outputting side and formed of soft material such as open or closed-cell foam, to provide comfort and sound insulation. The ear pad can be a hollow cylinder, or a solid cylinder formed of acoustically transparent material to allow sound propagation from the sound outputting element (e.g. a speaker or other sound generating component) to the person's ear.

Each of the rims 51A and 151B can include a joint which couples the rim to its respective earpiece. The joint can be a pivot shaft which extends from the rim into a slot in the earpiece. For example, rim 151A can include a pivot shaft 140A which is coupled to earpiece 102A to allow the sound output element to rotate around axis 142A. Rotation of the earpieces in this axis can provide comfort for the user during use, such as providing proper alignment of the opposing earpieces with the ears. Other movement mechanisms can also be used to allow adjustment of an earpiece relative to the user's ear.

The headband, telescoping elements, and earpieces can be formed of synthetic resin or corrosion-resistant metal. In addition, the headband and the telescoping elements can be made of a resilient material such as plastic, and define a generally curve shape.

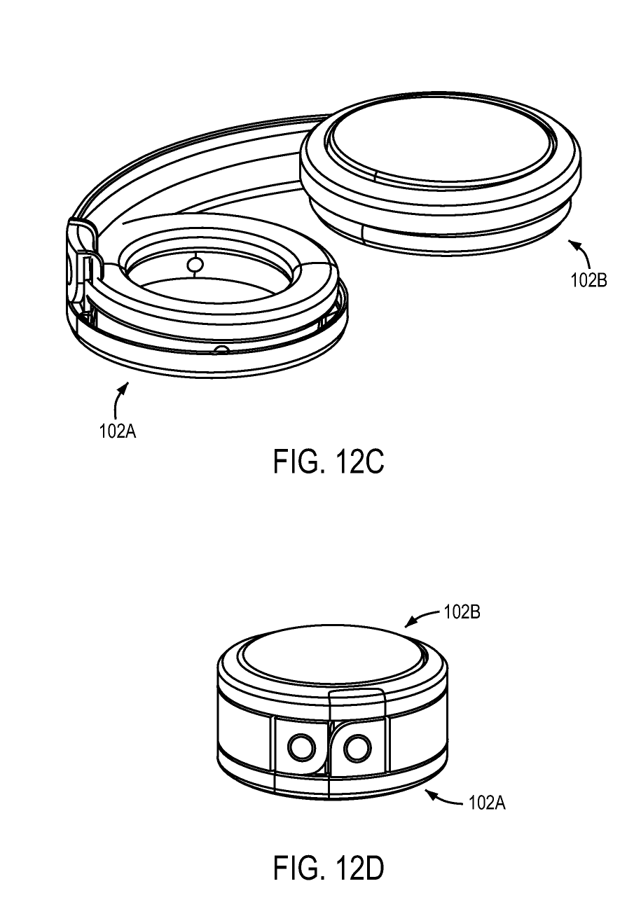

The collapsible headphone can be collapsed when not in use. In an embodiment, the earpieces are rotated in directions relative to the headband. For example, earpiece 102B can rotate about 90° in direction 126B around hinge 122B and then rotate about 90° in direction 128B around hinge 124B to make the earpiece 102B to be parallel to the headband curvature (as shown in FIGS. 1H and 12C). Alternatively, earpiece 102B can rotate first in direction 128B before rotating in direction 126B. The two earpieces can be rotated in opposite directions, to arrange them adjacent to one another with the headband wrapping around the earpieces. The transition between the state shown in FIG. 1A and the state shown in FIG. 1B is shown in FIGS. 1C through 1R and is also shown in FIGS. 12A through 12D. Going from FIG. 1R to FIG. 1C shows the transition to collapse the headphone, and going in the reverse direction from FIG. 1C to FIG. 1R shows the transition to expand the headphone from the collapsed state. From the state shown in FIG. 1A and FIG. 12A, a user can rotate earpiece 102B about hinge 122B and can rotate earpiece 102A about hinge 122A on joint 106A; these hinges can be designed to allow only a limited (e.g. 90° maximum) rotation in only the allowed direction so that a user cannot rotate them in a way that will prevent collapsing. After rotating both earpieces in this way (and after shrinking the telescoping elements), the headphone now has the state shown in FIG. 12B and in FIG. 1J. Next, the user can rotate earpiece 102B about hinge 124B and can rotate earpiece 102A about hinge 124A to produce the state shown in FIG. 12C and in FIG. 1H; FIG. 1I shows the two earpieces partially rotated about their respective hinges 124A and 124B. Next, the user can push the two earpieces 102A and 102B toward each other such that the sound outputting surfaces face each other to produce the state shown in FIGS. 1B and 12D.

The collapsible headphone can be made with or without telescoping elements. The telescoping elements allow flexibility in headband adjustments. FIG. 1A illustrates a telescoping element design where the telescoping elements 116A and 116B can be extend from and retract to an interior of the headband, between the support portion 112 and the liner portion 114.

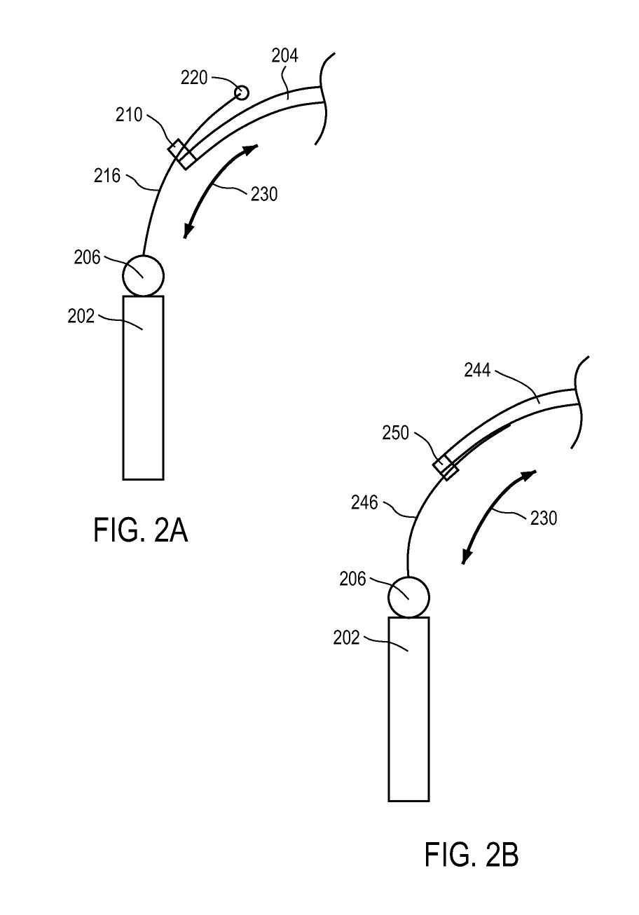

FIGS. 2A and 2B illustrate other telescoping configurations according to other embodiments of the present invention. FIG. 2A shows a telescoping element 216 sliding outside a headband 204 through a slider 210 at one end of the headband 204. The telescoping element 216 can be made of metal, such as stainless steel, or plastic. One end of the telescoping element 216 is coupled to ball joint 206 to link to earpiece 202. Ball joint 206 is shown, but other joint configurations, such as a set of hinges as shown in FIG. 1A, can be used. The other end of the telescoping element is free, and can be attached to a stopper 220 to prevent the telescoping element 216 from sliding out of the headband. The telescoping element 216 can be extended and retracted 230 with respect to the headband 204, for example, through one or more sliders 210. One slider 210 is shown in FIG. 2A, where the telescoping element 216 can be flexed out of the headband 204. Multiple sliders can be used (not shown) to keep the telescoping element 216 along the side of the headband.

FIG. 2B shows a telescoping element 246 sliding inside a headband 244 through a slider 250 at one end of the headband 244. The telescoping element 246 can he extended and retracted 230 with respect to the headband 244, for example, through one or inure sliders 250. With the slider 250 positioned at the inside of the headband, the telescoping element 246 can slide along the inside of the headband. Other configurations for telescoping elements that provides an extending and retracting movement of the earpieces with respect to the headband are also within the scope of the present invention.

The headphone comprises two earpieces for delivering sound to a user's ears. Each earpiece typically comprises a speaker encased in a protective housing with a sound output surface of the speaker facing the person's ear. The sound output surface can have hollow portions, be acoustically transparent, e.g., covered with a foam material or cloth, or a combination of hollow surface with foam cover. The earpieces can be on-ear, pressing on the user's ears. The earpieces can be over-the-ear, encompassing the entire ear with padding. Over-the-ear earpieces are typically larger, but can provide more comfort and higher quality sound with noise blockage.

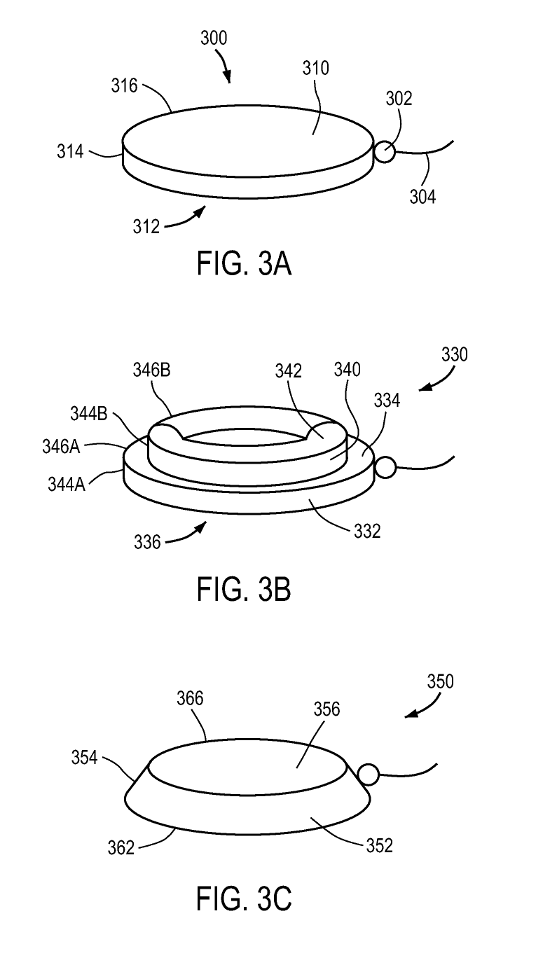

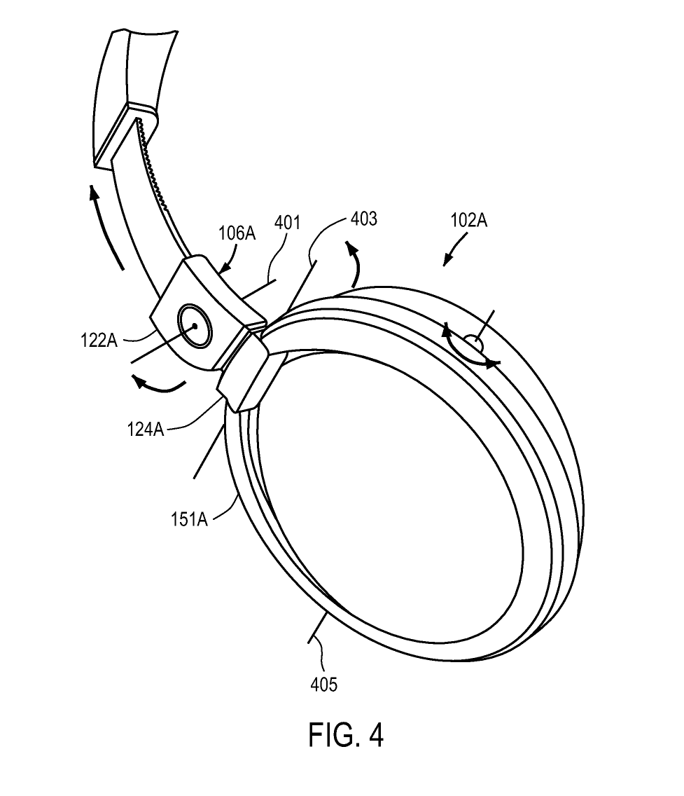

FIGS. 3A-3C illustrate exemplary configurations for the earpieces according to embodiments of the present invention. FIG. 3A shows an earpiece 300, which could be used as an on-ear earpiece, having a cylindrical shape coupled to a ball joint 302 which couples to a headband 304. A cylindrical shape and a ball joint are shown for illustrative purpose, and other shapes and types of joint or joints can be used. The earpiece 300 comprises a sound output surface 310, which is to face the person's ear to transmit the sound. The sound output surface 310 is acoustically transparent, for example, by having holes and/or covered with a cloth layer. The earpiece also comprises an opposite surface 312 opposite the sound output surface 310, facing the outside of the person's head. In between and separating the two surfaces 310 and 312 is a side surface 314, which is to be surrounded by the headband when the headband is wrapped around earpiece 300 according to an embodiment of the present invention. The side surface 314 can be viewed as extending (e.g., outward from the person's ear) from an outer edge 316 of the sound output surface 310.

FIG. 3B shows another earpiece 330, which could he used as an over-the-ear earpiece, comprising a housing 332 enclosing a speaker element (not shown). The housing 332 has a cylindrical shape, which can be solid or hollow. The housing 332 has a side 334 facing the person's ear for directing sound to the ear, an outer opposite surface 336 which is opposite to the facing-the-ear side 334. Coupled to the speaker housing 332 is an ear pad 340, which is typically hollow to cover the ear. The ear pad 340 has an inner surface 342, which is to he in close proximity with the person's ear.

In between and separating the outer and inner surfaces 336 and 342 is a side surface 344A/344B, a portion of which (e.g., housing portion 344A or pad portion 344B) is to he wrapped around by the headband according to an embodiment of the present invention. For example, the headband can wrap around the housing portion 344A (whole or part), around the pad portion 344B (whole or part), or around both portions (whole or part). The side surface 344A/344B can be viewed as extending from an outer edge 346A/346B of the sound output surface 334/342, inwardly or outwardly.

FIG. 3C shows another earpiece 350, which could be used as an over-the-ear or on-ear earpiece, having a graded or sloped cylindrical shape with a sound output surface 356 facing a person's ear, an opposite surface 352 facing the outside, and a graded side 354 between the two surfaces 356 and 352. In an embodiment, the graded side 354 can be used to accommodate the wrapping of the headband around the earpiece, for example, to provide support to the earpiece against compressed force perpendicular to the sound output or opposite surfaces. As shown, the sound output surface 356 has a circumference (or perimeter) 366 smaller than a circumference (or perimeter) 362 of the opposite surface 352. Other configurations for a modified cylinder are also within the scope of the present invention, for example, a cylindrical shape with opposite surface smaller than the sound output surface.

For added comfort, the earpiece can have an extra degree of freedom, for example, rotatable in a horizontal axis to conform the earpiece to the contour of the person's head. In an embodiment, the sound output surface of the earpiece can move, e.g., rotate, with respect to other portions of the earpiece. For example, the earpiece can comprise a frame coupled to the headband through one or more joints. The earpiece can further comprise a housing containing the speaker, wherein the housing can be rotated relative to the frame.

FIG. 4 shows an example of how the earpiece can rotate relative to a frame; in this example the earpiece is earpiece 102A of FIG. 1A and a hinge created by pivot shall 140A can allow earpiece 102A to rotate about axis 405 while the earpiece 102A remains attached to rim 151A. FIG. 4 also shows that hinge 124A allows rotation of earpiece 102A around the axis 403 and hinge 122A allows rotation of earpiece 102A around axis 401. It will be understood that earpiece 102B can also have the same set of hinges to provide for the same types of rotation.

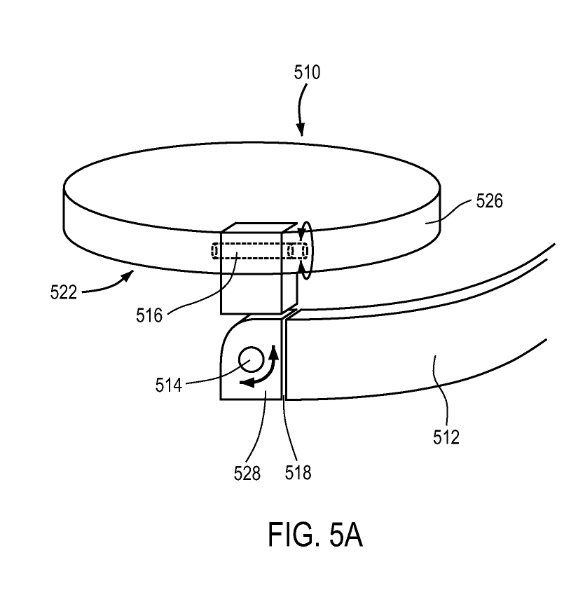

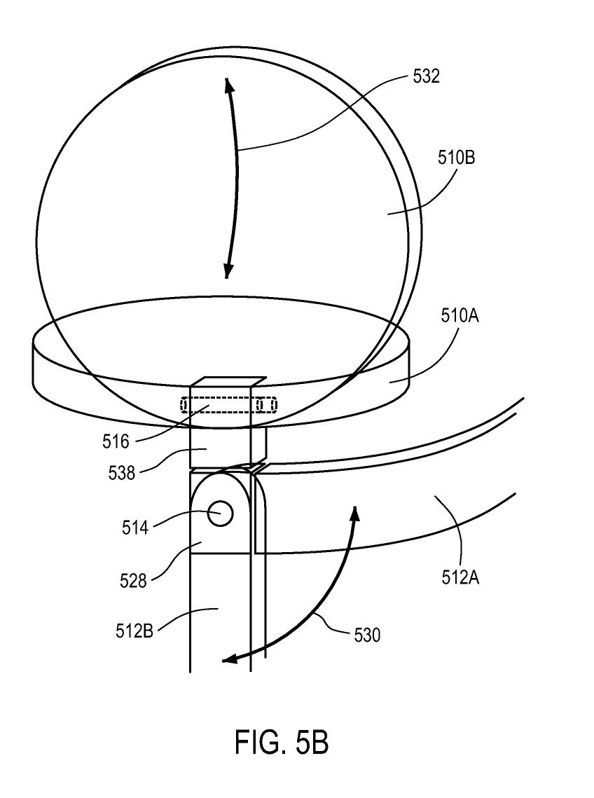

FIGS. 5A and 5B illustrate an exemplary set of hinges coupling a headband with an earpiece according to an embodiment of the present invention. FIG. 5A shows a schematic drawing of a partially collapsed configuration of an earpiece 510 coupled to a headband 512 through two hinges 514 and 516. In the collapsed configuration, the earpiece 510 has a sound output surface 522 that faces down in FIG. 5A and an opposite surface that faces up in FIG. 5A. The earpiece 510 has a side 526 extending outwardly away from the headband, and another side extending inwardly (not shown) toward the headband. The headband then can wrap around a perimeter of the side 526 of the earpiece. The headband can comprise a telescoping element 518 connecting the main headband portion with the hinge 514, for example, through an intermediate part 528. The configuration of earpiece 510, as shown in FIG. 5A, is the same as the configuration of one of the earpieces shown in FIG. 12C.

FIG. 5B shows exemplary movements for collapsing the headphone according to an embodiment of the present invention. The headband 512 can rotate, relative to the earpiece 510, in a first direction 530 between position 512A and 512B using hinge 514 which can be the same as hinges 122A and 122B in the embodiment of FIGS. 1A and 1B. Hinge 514 can comprise a rod or axle connected to an intermediate part 528, which is coupled directly to the headband main portion or to the telescoping element 518. The size of the immediate part 528 is about a few percents of the headband main portion, for example, about 10%. The headband, when collapsed, wraps around about 80% of the side of the earpieces, and the two intermediate parts wrap around the remainder of the earpiece perimeter in one embodiment.

The earpiece 510 can rotate, relative to the headband, in a second direction 532 between position 510A and 510B using hinge 516 which can he the same as hinges 124A and 124B in the embodiment of FIGS. 1A and 1B. Hinge 516 can comprise a rod or axle connected to a hinge portion 538, which couples to hinge 514 to allow the earpiece and the headband to rotate with respect to one another in first direction 530. The earpiece is then coupled to hinge portion 538 for relatively rotating in second direction 532 with respect to hinge portion 538. Using these hinges, the headphone can be collapsed with the hinges wrapping around the earpieces, e.g., the perimeter or the side of the earpieces, leaving no gap between the hinges and the earpiece portions.

The angle of rotation can he about 90°. The headphone is in a collapsed configuration with the headband in position 512A and the earpiece in position 510A. The headphone is in a usable configuration with the headband in position 512B and the earpiece in position 510B. The rotation can be performed in either sequence, for example, first in direction 530 and then in direction 532, or first in direction 532 and then in direction 530.

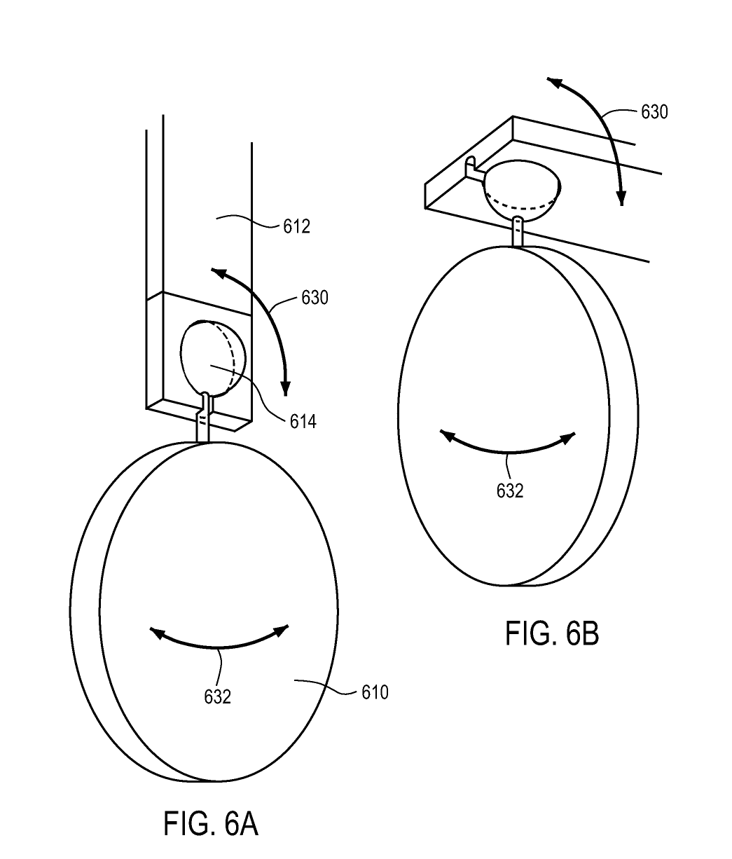

FIGS. 6A and 6B illustrate an exemplary set of ball joints coupling a headband with an earpiece according to an alternative embodiment of the present invention. A single ball joint that couples an earpiece to the headband can be used instead of the set of hinges (e.g. 122B and 124B) for each earpiece as in the embodiment shown in FIGS. 1A and 1B. FIG. 6A shows the headphone in the in-use configuration, with the earpiece 610 extended from the headband 612 through the ball joint 614. The headband 612 can be collapsed in direction 630 substantially perpendicular to the earpiece 610. The earpiece 610 can also be collapsed in direction 632 substantially perpendicular to the headband 612. FIG. 6B shows a partially collapsed configuration, where the headband 612 can wrap around a side of the earpiece 610.

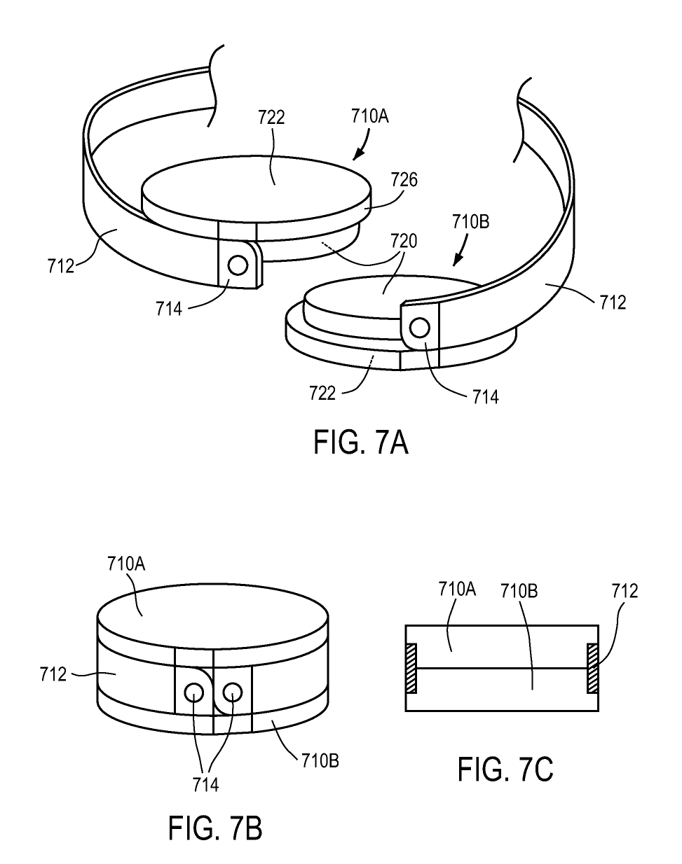

FIGS. 7A-7C illustrate partially and fully collapsed configurations for the present headphone according to an embodiment of the present invention. The embodiment shown in FIGS. 7A-7C can use the same set of hinges, for each earpiece, as the embodiment shown in FIGS. 1A and 1B. FIG. 7A shows the collapsible headphone in a partially collapsed state, with the earpieces 710A and 710B folded parallel to the headband 712 through the set of joints 714. The earpieces 710A and 710B each comprise an inner surface 720 facing the ear and folded facing each other in the collapsed configuration, and an outer opposite surface 722 facing away from each other in the collapsed configuration. The inner surfaces 720 are also sound output surfaces, configured to direct sound to the ears. The inner surfaces 720 are preferably sound transparent. In between the outer and inner surfaces is side surface 726. With the outer opposite surface 722 larger than the inner sound outputting surface 720, the side surface 726 can exhibit a step or can be a graded surface (see, for example, FIG. 3C). The headband then wraps around the inner surface under the outer surface, for example, around a portion of the side surface 726 or around a perimeter/circumference of the inner surface. In an embodiment, each earpiece can include a rim, such as rim 151A, and each rim can have a circumference or perimeter that is larger than the circumference or perimeter of the inner surface, and the headband still wraps around the inner surface inside the outer perimeter of the rim. In this configuration, the headband can provide support to the earpieces, for example, from damaged by being accidentally stepped on.

FIG. 7B shows the collapsible headphone in a fully collapsed configuration, forming a compact cylindrical structure resembling a hockey puck. FIG. 7C shows a cross section of the fully collapsed structure. The top and the bottom areas of the collapsed structure are formed from the two earpieces folded facing each other, and the side area of the collapsed structure is formed from the headband wrapping around the two earpieces. In this collapsed configuration, there are no exposed parts that can be easily broken, thus the headphone is fully protected when collapsed. Additionally, the headband wraps around the earpieces such that the headband, in one embodiment, does not leave a gap between the headband and at least a side or a portion of a side of the earpieces. Expected variations of this structure are also within the scope of the present invention, for example, adding a hook for a carrying chain.

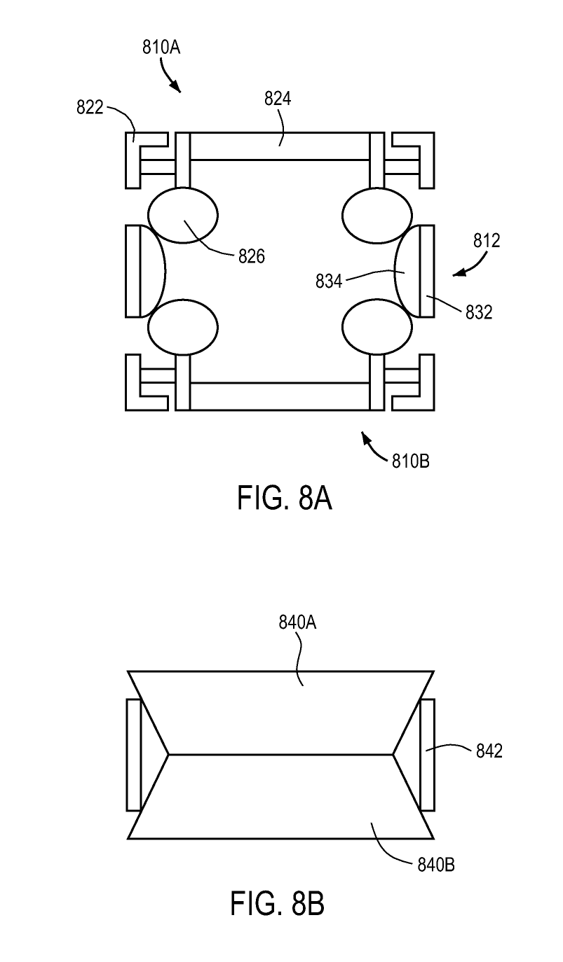

FIGS. 8A-8B illustrate other fully collapsed configurations for the present headphone according to alternative embodiments of the present invention. FIG. 8A shows a cross-sectional view of the collapsed headphone, comprising two earpieces 810A and 810B folded facing each other with headband 812 wrapping around the earpieces 810A and 810B. The earpieces each comprise an outer frame 822 coupled to speaker housing 824 and soft ear pad 826. The frame 823 can be the same as or similar to the rims (e.g. rim 151A) in the embodiment of FIGS. 1A and 1B. The headband 812 comprises a support band 832 coupled to a soft liner 834. The support hand wraps around the earpieces and is disposed between the frames 822. The soft liner 834 and the ear pads 826 can be deformed somewhat inside the folded structure, and can be protected with the hard shell of the headphone, e.g., the frame 822, the support band 832, and the hard outer housing 824 of the speaker elements.

FIG. 8B shows a cross-sectional view of another collapsed headphone configuration according to an embodiment of the present invention. The headband 842 wraps around the earpieces 840A and 840B in a portion of the graded or sloped sides of the earpieces.

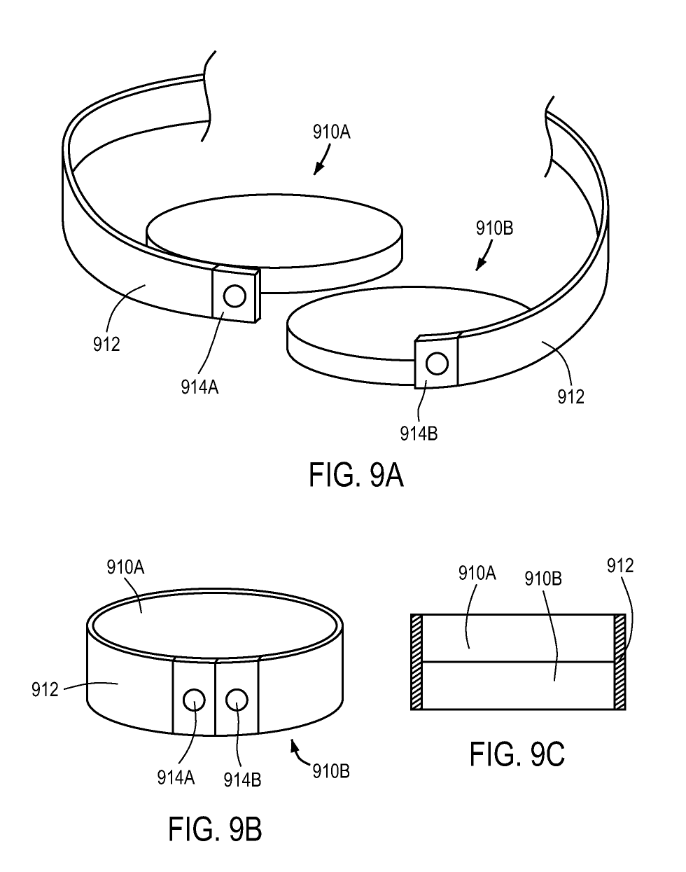

FIGS. 9A-9C illustrate partially and fully collapsed configurations for the present headphone according to another embodiment of the present invention. FIG. 9A shows the collapsible headphone in a partially collapsed state, with the earpieces 910A and 910B folded parallel with the headband 912 through the set of joints 914A and 914B. The headband wraps around the earpieces in less than one turn, with the remaining portion around the side of the earpieces being covered by the joints 914A and 914B. FIG. 9B shows the collapsible headphone in a fully collapsed configuration, forming a compact cylindrical structure resembling a hockey puck. FIG. 9C shows a cross section of the fully collapsed structure.

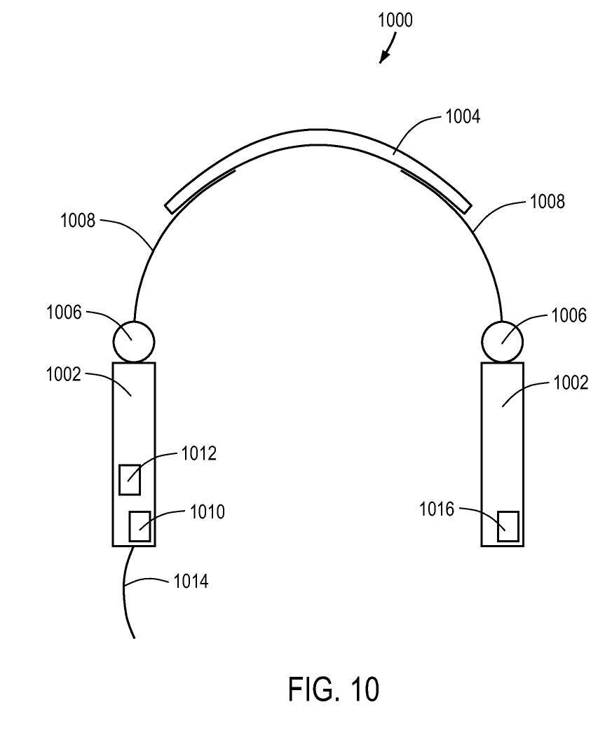

In an embodiment, the present collapsible headphone comprises optional components, such as microphones, earpiece jacks, corded, wireless components, and electronic circuits with antenna and/or battery. FIG. 10 illustrates an exemplary collapsible headphone according to an embodiment of the present invention. The collapsible headphone 1000 comprises earpieces 1002, headband 1004 with telescoping elements 1008 coupled to the earpieces by joints 1006. Optional one or more microphones 1010, one or more earpiece jacks 1012 for electrical connection with the earpieces (speakers and/or microphones), one or more cords 1014 for electrical connection with the earpieces (speakers and/or microphones), wireless receiver 1016 having antenna, electronic circuits and/or battery.

A microphone can be located within the earpiece, which can be a directional microphone. The microphone can be surrounded with sound-absorbing material to minimize transmission of external noise into the microphone. The microphone can be designed to pick up sound transmitted through the air from the person's mouth, or the microphone can pick up sounds coming out through the person's ear canal.

A wireless transmitter and/or receiver can be embedded in the collapsible headphone for transmitting microphone signals and/or receiving signals for outputting to the speakers. For example, a microphone located within the earpiece delivers electrical signals to a wireless radio transmitter. A speaker within the earpiece receives electrical signals from a wireless radio receiver. Portable batteries can he included in the headphone to provide operating power.

The headphone can include a jack which is configured to receive one or more connection cords adapted for connection to external circuits, such as an acoustic equipment. Alternatively, the headphone can include connection plugs or jacks. The headphone can include one or more wireless circuits employing one or more wireless protocols such as Bluetooth for wireless transmission.

Other components can also be included, for example, a mute button to disconnect the microphone, or a volume adjustment knob to adjust the volume of the speakers. Other controls can be included, for example, for adjusting the sound pick-up characteristics or adjusting the sound output characteristics. The headphone can include an antenna, which, for example, can be built into the headband.

In an embodiment, the present invention includes methods to collapse a headphone to a compact structure that is self protected and becomes its own case. The headphone can, in one embodiment, when collapsed match the components (e.g., the headband, the earpieces and the joints) together by leaving no component which protrudes from the collapsed structure. In addition, the outer parts of the headphone components can comprise outer shells of high hardness materials to prevent damage to the headphone. Also, the collapsed configuration presents a self protected shape, such as flat cylinder, to be able to withstand high forces in one embodiment. Thus when collapsed, the present headphone behaves like being encased in a protective case, with the walls of the enclosed case being part of the headphone itself.

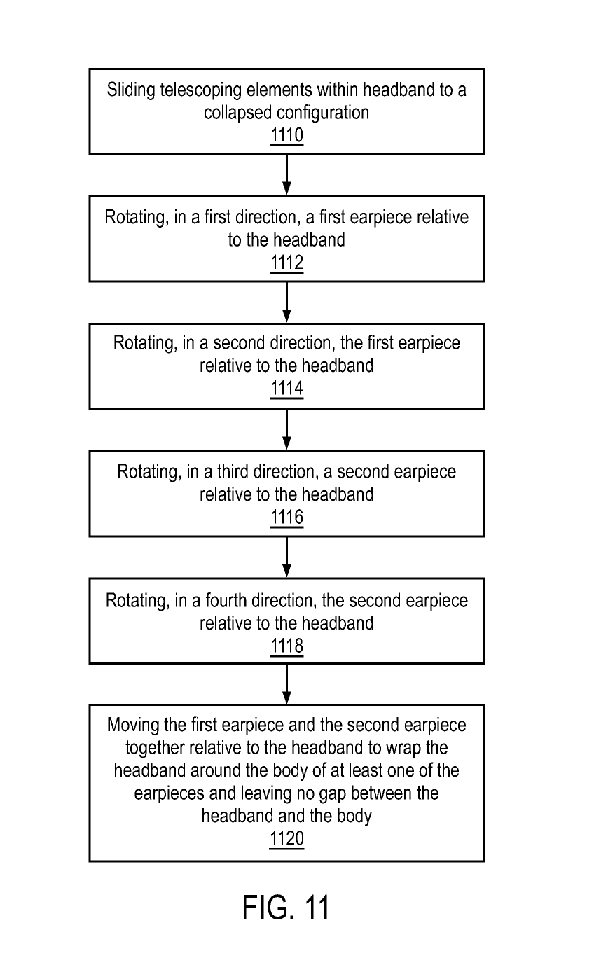

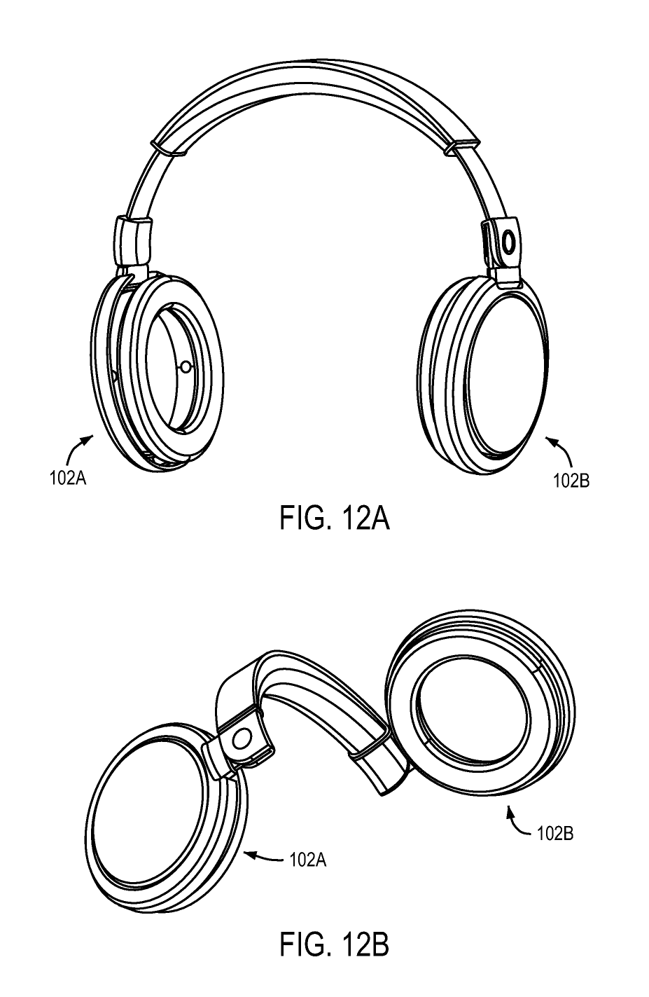

FIG. 11 illustrates a method for collapsing a headphone according to an embodiment of the present invention. Operation 1110 optionally retracts the telescoping elements of the headphone. For example, the telescoping elements can he retracted into the inside of the headband. The telescoping elements are preferably retracted in a configuration that does not expose the telescoping elements outside the headband, so that the telescoping elements are protected within the folding configuration of the headphone. In an embodiment, the headband has a length less than a perimeter of the earpieces, so that it can wrap around the earpieces within one turn. Preferably, the length of the headband and the portion of the joints connecting the headband to the earpieces, are about to form one complete turn around the earpieces. Operations 1112 and 1114 rotate the first earpiece in a first and second direction relative to the headband, and operations 1116 and 1118 rotate the second earpiece in a third and fourth direction relative to the headband, so that the earpieces are positioned parallel to the headband (for example, the earpieces 102A and 102B are positioned as shown in FIG. 12C). In this position, the headband is parallel to a side of the earpieces. The headband can be totally outside the earpieces, covering all sides of the earpieces. Alternatively, the headband can be partially outside the earpieces, covering only a part of the earpieces, such as the soft parts of the earpieces, e.g., the ear pads. The rotation can comprise two rotational movements, a first rotating action in a first direction followed by a second rotating action in a second direction. In operation, the earpieces are positioned extended from the headband, with the sound output surfaces and the opposite surfaces parallel to the width of the headband. The two rotating movements turn the earpieces so that a side of the earpieces becomes parallel to the width of the headband, and that the headband becomes somewhat tangential to this side of the earpieces. For example, the rotating movements can comprise a first rotation about 90° perpendicular to the tangent at an end of the headband, followed by a second rotation also about 90° perpendicular to the tangent.

Operation 1120 moves the earpieces together relative to the headband to wrap the headband against the body of the earpieces. The wrapping of the headband is designed to fit the earpieces to form a protected case, leaving no gap between the headband and the body of the earpieces, leaving no exposure of breakable parts outside of the encasing form.

Other systems, methods, features, and advantages of the present invention will be or become apparent to one with skill in the art upon examination of the following drawings and detailed description. It is intended that all such additional systems, methods, features, and advantages be included within this description, he within the scope of the present invention, and he protected by the accompanying claims.

What is claimed is:

1. A headphone comprising:
a headband;
a first earpiece having a first sound output surface configured to direct sound to an ear, a first opposite surface and a first side disposed between and separating the first sound output surface and the first opposite surface;
a second earpiece having a second sound output surface configured to direct sound to another ear, a second opposite surface and a second side disposed between and separating the second sound output surface and the second opposite surface;
a first joint coupling the first earpiece to the headband;
a second joint coupling the second earpiece to the headband;
wherein the first joint, the second joint, and the headband are configured to cause the headband, when the headphone is collapsed, to wrap around at least one of the first side and the second side such that the headband does not leave a gap between the headband and at least one of the first side and the second side and wherein the headband comprises at least two telescoping elements.

2. The headphone as in claim 1 wherein when the headphone is collapsed, the first sound output surface and the second sound output surface face each other.

3. The headphone as in claim 2 wherein the first joint is a first ball joint and the second joint is a second ball joint.

4. The headphone as in claim 2 wherein the first joint is a first set of hinges and the second joint is a second set of hinges.

5. The headphone as in claim 4 further comprising:
a microphone attached to one of the first earpiece and the second earpiece.

6. The headphone as in claim 4 further comprising:
an earpiece jack having an output coupled to a first speaker in the first earpiece and a second speaker in the second earpiece.

7. The headphone as in claim 4 further comprising:
a wireless transceiver having an output coupled to a first speaker in the first earpiece and an output coupled to a second speaker in the second earpiece and an input coupled to a microphone.

8. The headphone as in claim 7 further comprising:
an earpiece jack coupled to the first speaker and to the second speaker.

9. The headphone as in claim 8 further comprising:
a microphone attached to one of the first earpiece and the second earpiece.

10. The headphone as in claim 9 wherein the first joint and the second joint wrap around the at least one of the first side and the second side when the headphone is collapsed.

11. A headphone comprising:
a headband;
a first earpiece having a first sound output surface and a first side extending from an outer edge of the first sound output surface;
a second earpiece having a second sound output surface and a second side extending from an outer edge of the second sound output surface;
a first hinge coupling the headband to a first intermediate part;
a second hinge coupling the first intermediate part to the first earpiece;
a third hinge coupling the headband to a second intermediate part;
a fourth hinge coupling the second intermediate part to the second earpiece;
wherein the first, second, third and fourth hinges are configured to cause the headband, when the headphone is collapsed, to wrap substantially around the perimeter of at least one of the first side and the second side.

12. The headphone as in claim 11 wherein the headband, when the headphone is collapsed, wraps around over about 80% of the first side and wherein the first and the second intermediate parts wrap around the remainder of the perimeter.

13. The headphone as in claim 11 wherein the first, second, third and fourth hinges wrap around the perimeter and leave no gap between the respective hinge and the perimeter.

14. The headphone as in claim 11 wherein when the headphone is collapsed, the first sound output surface and the second sound output surface face each other and wherein the headband comprises at least two telescoping elements.

15. The headphone as in claim 14 further comprising:
a microphone attached to one of the first earpiece and the second earpiece.

16. The headphone as in claim 14 further comprising:
an earpiece jack coupled to a first speaker in the first earpiece and a second speaker in the second earpiece.

17. The headphone as in claim 14 further comprising:
a wireless receiver having an output coupled to a first speaker in the first earpiece and a second speaker in the second earpiece.

18. The headphone as in claim 17 further comprising:
an earpiece input jack coupled to the first speaker and to the second speaker.

19. A method for collapsing a collapsible headphone, the method comprising:
sliding telescoping elements within a headband to a collapsed configuration;
rotating, in a first direction, a first earpiece relative to the headband;
rotating, in a second direction, the first earpiece relative to the headband;
rotating, in a third direction, a second earpiece relative to the headband;
rotating, in a fourth direction, the second earpiece relative to the headband;
moving the first earpiece and the second earpiece together to wrap the headband against the body of at least one of the earpieces and leaving no gap between the headband and the body.

20. The method as in claim 19 wherein when the first and the second earpieces are moved together, hinges, which couple the headband to the first and the second earpieces, wrap around the body.

21. A headphone comprising:
a headband;
a first earpiece having:
a first sound output surface configured to direct sound to an ear;
a first opposite surface surrounded by a first rim having a perimeter that is larger than the perimeter of the first sound output surface; and
a first side disposed between and separating the first sound output surface and the first opposite surface;
a second earpiece having:
a second sound output surface configured to direct sound to an ear;
a second opposite surface surrounded by a second rim having a perimeter that is larger than the perimeter of the second sound output surface; and
a second side disposed between and separating the second sound output surface and the second opposite surface;
a first joint coupling the first earpiece to the headband;
a second joint coupling the second earpiece to the headband;
wherein the first joint, the second joint, and the headband are configured to cause the headband, when the headphone is collapsed, to wrap around the first side and the second side such that the headband is between and adjacent to the first rim and the second rim and such that the headband and the first rim and the second rim support the first and second earpieces in a direction perpendicular to the first and second sound output surfaces.

22. The headphone as in claim 21 wherein when the headphone is collapsed, the first sound output surface and the second sound output surface face each other, and wherein the headband comprises at least two telescoping elements.

23. The headphone as in claim 22 wherein the first joint is a first ball joint and the second joint is a second ball joint.

24. The headphone as in claim 22 wherein the first joint is a first set of hinges and the second joint is a second set of hinges.

25. The headphone as in claim 24 wherein a portion of the first joint and the second joint wraps around the first side and the second side when the headphone is collapsed.

26. The headphone as in claim 25 further comprising:
a microphone attached to one of the first earpiece and the second earpiece.

27. The headphone as in claim 25 further comprising:
an earpiece jack coupled to a first speaker in the first earpiece and a second speaker in the second earpiece.

28. The headphone as in claim 25 further comprising:
a wireless receiver having an output coupled to a first speaker in the first earpiece and a second speaker in the second earpiece.

29. A headphone comprising:
a headband;
a first earpiece having a first sound output surface configured to direct sound to an ear, a first opposite surface and a first side disposed between and separating the first sound output surface and the first opposite surface;
a second earpiece having a second sound output surface configured to direct sound to another ear, a second opposite surface and a second side disposed between and separating the second sound output surface and the second opposite surface;
a first joint coupling the first earpiece to the headband;
a second joint coupling the second earpiece to the headband;
wherein the first joint, the second joint, and the headband are configured to cause the headband, when the headphone is collapsed, to wrap around the first side and the second side such that the headband creates a flush surface surrounding the collapsed headphone.

30. The headphone as in claim 29 wherein when the headphone is collapsed, the first sound output surface and the second sound output surface face each other.

31. The headphone as in claim 30 further comprising:
a microphone attached to one of the first earpiece and the second earpiece.

32. The headphone as in claim 31 further comprising:
a wireless transceiver having an output coupled to a first speaker in the first earpiece and an output coupled to a second speaker in the second earpiece and an input coupled to the microphone.
